(19) United States
(12) Patent Application Publication
(10) Pub. No.: US 2019/0322391 A1
(43) Pub. Date: Oct. 24, 2019

(54) AIRCRAFT ENGINE INSTALLATION/REMOVAL AND TRANSFER DEVICE

(71) Applicant: NEXT AERO CONCEPT, TARBES (FR)

(72) Inventor: Thomas LAMADON, TARBES (FR)

(21) Appl. No.: 16/348,757

(22) PCT Filed: Nov. 10, 2017
(86) PCT No.: PCT/FR2017/053076

§ 371 Date: May 9, 2019

(30) Foreign Application Priority Data
Nov. 10, 2016 (FR) FR1660908

(51) Int. Cl. B64F 5/50; F01D 25/28; B64F 5/10

(52) U.S. Cl. CPC B64F 5/50; B64F 5/10; F01D 25/285

(57) ABSTRACT

The invention relates to an aircraft engine (20) installation/removal and transfer device in the form of a dolly (100) comprising, on the one hand, a chassis (110) mounted on idle wheels (111, 112, 113, 114) and, on the other hand, a cradle (150) for receiving said engine (20), said device being characterized in that it comprises pneumatic and/or hydraulic actuators (160), disposed as the interface between the chassis (110) and the cradle (150) and capable, on the one hand, of allowing lifting of the cradle with respect to the chassis and, on the other hand, of damping shocks and/or vibrations, said actuators allowing the cradle to be lifted into a first lifting position necessary for installing/removing the engine, then holding it in a second loaded rest position to damp vibrations and/or shocks undergone by the cradle-engine assembly with respect to the chassis.

### FIELD OF THE INVENTION

The invention relates to an aircraft engine installation, removal and transfer device. This device allows in particular the mounting of an engine on an aircraft and its removal for maintenance or changing operations. The transfer operations concern both the moving of the engine from a workshop to another and from a site to another, requiring road, maritime or air transport. These installation/removal or transfer operations take place during assembly of an aircraft for example, or during maintenance operations.

### PRIOR ART

The handling of such engines proves to be long and tedious because, though they are voluminous and heavy, these engines, when they are not in operation, have fragile components. The ball bearings of these engines, in particular, are very costly and very fragile parts which may easily deteriorate during transfer and installation or removal operations due to vibrations and/or shocks.

During removal operations, a system called a “bootstrap kit” in the field of aeronautics allows the engine to be separated from the wing of the aircraft and to be deposited on a dolly. The dolly comprises a chassis mounted on idle wheels and a removable cradle designed to accommodate the engine. More particularly, the “bootstrap kit” removal system appears in the form of a crane gantry. It allows the dolly's cradle to be lifted at four points and secured to the engine at four points distributed on either side of its center of gravity, two attachment points being positioned toward the front of the engine and two other attachment points being positioned toward the rear of the engine. The removal system then allows the cradle-engine assembly to rest on the chassis of the dolly, more particularly on shock absorbers made of flexible material of the rubber type, known under the designation “silentbloc,” and disposed between the chassis and the cradle. The cradle is then retained firmly on the chassis. However, if the silentblocs allow vibrations to be damped during transport, they do not allow the shocks which may possibly occur to be effectively damped.

It therefore proves necessary to adapt transport vehicles by adding to them an air cushion suspension system in order to damp shocks during the transportation of the engine. Thus, a truck and/or its trailer must for example be equipped with such an air ride suspension system on each axle. In this case, the dolly, on which the engine is disposed, is secured to the vehicle by its chassis, leaving the cradle free in order to retain the effectiveness of the silentblocs in absorbing vibrations

The installation/removal and the transfer of an aircraft engine is therefore delicate to implement, long, and costly because it necessitates the use of transportation means with suitable suspensions and specific lifting means that are difficult to handle and slow to install.

Solutions have been considered to simplify the operations of installing/removing the engine with a dolly equipped with lifting means.

To this end, the document U.S. Pat. No. 4,461,455 describes a lifting device suitable for the installation and removal of an aircraft engine. Nevertheless, this device is silent about damping vibrations and/or shocks suffered by the cradle-engine assembly relative to the chassis. Indeed, this document relates only to a device for lifting and positioning the engine and the cradle is not taken into consideration. Thus, this document does not propose a device for installing/removing and transferring an aircraft engine and requires the use of a transport means with suitable suspensions.

The document US2012/0110816 describes an installation/removal and transfer system in the form of a dolly comprising a chassis and a cradle. Lifting means allow lifting the cradle to deposit therein an aircraft engine once it is removed from its support. These lifting means are in the form of screw actuators connected to the cradle by means of joints. Each actuator functions independently of the others. During its positioning, the chassis further rests on air bearing sliders allowing the dolly to be displaced with little effort in order to position it accurately under the engine. These sliders are used only during this positioning phase of the dolly with respect to the engine. The dolly must then be loaded on a vehicle, the suspensions whereof are suitable to be able to damp the shocks and vibrations during transport.

This dolly always requires the use of a transport means with suitable suspensions. Consequently, the engine is not effectively protected during the phases of installation or removal, of movement between a removal area and a loading area, and of loading on a suitable vehicle.

The applicant has therefore searched for a way to simplify the construction of such a dolly to reduce the cost of its manufacture and allow its transportation on a standard vehicle not requiring any adaptation of its suspensions, to simplify its use, to protect the engine during all the phases of its life as soon as the latter leaves its position under the wing of an aircraft and finally to reduce the time required to carry out the complete removal or installation procedure.

### Technical Problem

Therefore, the aim of the invention is to correct at least one of the disadvantages of the prior art. The invention aims in particular to propose an improved aircraft engine installation/removal and transfer device which has simple construction, low cost, ease of use, capacity to be loaded into any type of transport means without requiring the adaptation of its suspensions, and allows the engine to be protected as soon as it leaves its position under the wing of an aircraft.

### BRIEF DESCRIPTION OF THE INVENTION

To this end, the invention has as its object an aircraft engine installation/removal and transfer device in the form of a dolly comprising, on the one hand, a chassis mounted on idle wheels and, on the other hand, a cradle for receiving said engine, said device being characterized in that it comprises pneumatic and/or hydraulic actuators, disposed as the interface between the chassis and the cradle and capable, on the one hand, of allowing lifting of the cradle with respect to the chassis and, on the other hand, of damping shocks and/or vibrations, said actuators allowing the cradle to be lifted into a first lifting position necessary for installing/removing the engine, then holding it in a second loaded rest position to damp vibrations and/or shocks undergone by the cradle-engine assembly with respect to the chassis. In a preferred but non limitating embodiment, the actuators make it possible to damp vibrations and shocks of the cradle-engine assembly relative to the chassis.

According to other optional features of the device:
the dolly comprises at least one additional securing and damping system, said complementary securing and damping system comprising at least two damping cylinders and a securing guide, said securing guide being fixed to the cradle, each of the damping cylinders being fixed at one end to the frame and being, at another end, mobile relative to the securing guide. Such a system makes it possible to create new support points of the cradle on the chassis to ensure additional damping, especially during the engine transfer phase and to secure engine installation and removal operations.
each of the damping cylinders of the additional securing and damping system comprises at least one pawl adapted to cooperate with the securing guide. The presence of at least one pawl makes it possible for the additional securing and damping system to operate more simply and to be designed at a lower cost. In addition, such a system is robust.
the chassis comprises support parts forming a housing for the actuators and in that each of the damping cylinders is fixed at one of its ends to the chassis through said support parts;
each of the damping cylinders comprises an axis positioned perpendicularly to an axis of elongation of the damping cylinder and in that said axis comprises at its ends at least one pawl. Thus, the maintain is more efficient and support of the important loads associated with the engine is improved.
the securing guide has the shape of a guide rail having a plurality of blocking members adapted to cooperate with the pawls so as to maintain in position the damping cylinders relative to the securing guide. Advantageously, the pawls only work when the cradle-engine assembly rises and allow to retain the load of the cradle-engine assembly in case of problem or leakage of one of the pneumatic and/or hydraulic actuators. The cradle-engine unit cannot come down without a specific and voluntary action from the operator. Indeed, the operator must actuate a safety button to unlock and retract the pawls of the axis of each of the damping cylinders so that it can proceed to the controlled descent of the cradle-engine assembly. In addition, the securing and additional damping system is preferably configured so that, if the operator had to release this safety button, the pawls would return to their original position in the locking member thus allowing to maintain the height of the cradle-engine assembly.
the cradle comprises at least two cross-members resting on said actuators, at the ends whereof are attached shock absorbers, the chassis comprising support parts forming a housing for the actuators.
the support parts include two lateral guidance vertical walls for the cross-members during the lifting of the cradle, a horizontal wall, support for the actuators, and a wall forming an abutment for the shock absorbers. The support parts may also comprise fixing means for fixing the damping cylinders.
the support parts are in the form of a seat, the seat portion whereof corresponds to the horizontal wall and the back whereof corresponds to the wall forming an abutment. Advantageously, said support parts are disposed to have a seat portion turned toward the cradle, the back corresponding to the wall forming an abutment which may be inclined with respect to a vertical axis from 0° to 89° and preferably from 1° to 20°. The combination of four inclined backs and emergency shock absorbers allows the cradle-engine assembly to position itself better within the device in the extreme case of failure of the hydraulic pneumatics and/or actuators and damping cylinders acting as second security level. The shock absorbers in contact with these inclined backs correspond to a third fall back solution where the other actuators and additional dampers would no longer work.
In another configuration, the support parts in the form of a seat may be disposed inversely, the seat portion being turned toward the outside of the chassis, the back corresponding to the wall forming an abutment being inclined with respect to a vertical axis from 0° to +89° and preferably from +1° to +20°.
when the actuators are pneumatic, they are inflated with air or with an inert and stable gas, and when they are hydraulic, they are filled with an incompressible liquid;
when the damping cylinders are hydraulic, they comprise an incompressible liquid, and when it is gas damping cylinder, they comprise an inert and stable gas;
when the actuators are pneumatic, the necessary pressure for attaining the first lifting position and relieve the wing of the aircraft of the weight of the engine is comprised between 1 bar and 10 bars, and preferably between 1 bar and 8 bars; and the necessary pressure for holding the loaded cradle in the second loaded rest position is comprised between 2 bars and 9 bars, and preferably between 4 bars and 8 bars; Such pressure makes it possible in particular to ensure a damping between 7 Hz and 10 Hz of the cradle—engine assembly relative to the chassis. The dolly, in this configuration, can then be moved to a loading area, and loaded, once the idle wheels folded, on a transport means to be transported safely. Such a dolly thus configured can be installed on a standard vehicle, such as a truck or a trailer, without the obligation to go through a carrier equipped with specialized air suspension equipment. Thus, the whole actuators and securing guide and additional dampers form a pneumatic suspension as effective as that found on a transport equipment recommended by aircraft engine manufacturers.
when the actuators are pneumatic, they are actuators with flexible membranes with at least one wave, and when they are hydraulic, they are actuators with rigid walls or with flexible membranes; the damping cylinders are preferably rigid wall cylinders.
the device includes at least two actuators disposed along a longitudinal median axis of the chassis.
the device comprises at least three actuators, at least two of which are disposed, preferably in the front, on either side of the longitudinal median axis of the chassis;
advantageously, the actuators are four in number, each being disposed as the interface between the end of a cross-member of the cradle and the chassis, and in that at least the actuators disposed under the same cross-member of the cradle are in identical pairs,
each actuator may operate independently of the others or may operate in parallel with one or more other actuators, as needed;
the cradle comprises on the upper ends of two vertical posts a receiving part the upper surface whereof has an opening with walls inclined in the shape of a “V”, in order to facilitate the introduction of attachment parts attached to the engine; these inclined-walled receiving part allow the cradle to finish well positioned relative to the engine during the installation of the cradle under the engine at the beginning of the engine removal operation.
the device further comprises one or two retaining bars of the rear portion of the engine. Preferably, the device further comprises two retaining bars of the rear part of the engine. These retaining bars make it easier to hold the engine on the cradle and transmit the load of the engine to the cradle.
the idle wheels are adapted to be folded. Thus, the device according to the invention can easily be placed in a transport means for its transfer.

The invention also applies to an aircraft engine installation/removal and transfer method, said method being characterized in that it is implemented by means of the device as described above and during removal, it comprises the following steps:
a first step of positioning the dolly perpendicular to the engine and of inflating the actuators to position the cradle so that the attachment parts, previously attached to the engine, are inserted into the receiving parts disposed at the end of the vertical posts of the cradle, preferably, the idle wheels are then braked,
a second load-shedding step, consisting of inflating the actuators to a load-shedding pressure, for relieving the wing of the aircraft from the weight of the engine, and separating the engine from the aircraft wing,
a third disengagement step, according to which the actuators are deflated to lower the cradle to a height allowing movement of the dolly out of the area under the aircraft wing,
a fourth damping step, consisting of inflating the actuators to a pressure for damping the cradle-engine assembly, said cradle then being in a loaded rest position,
a fifth step consisting of moving the dolly toward a loading area, then loading it on a transportation means and

during installation of the engine, the steps implemented are performed in the reverse order of removal.

### PRESENTATION OF THE FIGURES

Other particular features and advantages of the invention will appear upon reading the following description, given by way of an illustrative and not limiting example, with reference to the appended figures which show:

FIGS. 1A and 1B, schematic views in front perspective of two devices according to the invention loaded with an aircraft engine, the cradle being disposed in rest position, the devices according to the invention are represented with (1B) and without (1A) the additional securing and damping system;

FIG. 2, a schematic view in rear perspective of the device of FIG. 1A,

FIG. 3, a schematic view in front perspective of a device according to the invention when the cradle is in the lifting position.

FIGS. 4A and 4B are schematic front (4A) and bottom (4B) views of the additional securing and damping system according to the invention.

### DETAILED DESCRIPTION OF THE INVENTION

The device according to the invention described hereafter, allows the installation or removal and the transfer of the aircraft engine. It is particularly suitable for civil and military aircrafts equipped with engines under the wings.

Hereafter in the description, the same reference symbols are used to designate the same elements.

“Longitudinal axis” means a direction parallel to the ground and along the length of the dolly.

For the purposes of the invention, the term “substantially constant” means a value varying from less than 30% relative to the value compared, preferably from less than 20%, even more preferably from less than 10%.

“Transverse” or “transverse direction” means a direction parallel to the ground and along the width of the dolly.

“Vertical” means a direction along an axis perpendicular to the ground.

By “transfer” it is necessary to understand the transfer operations concerning the movement of the engine as well from one workshop to another than from one site to another, requiring a road, sea or air transport. Preferably, the device is adapted to allow damping of shocks and vibrations during road, sea or air transport operations.

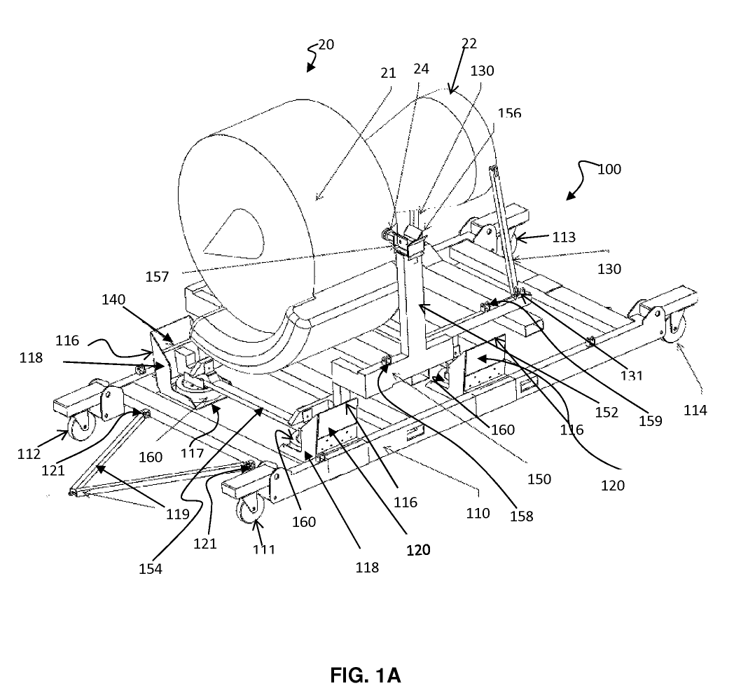

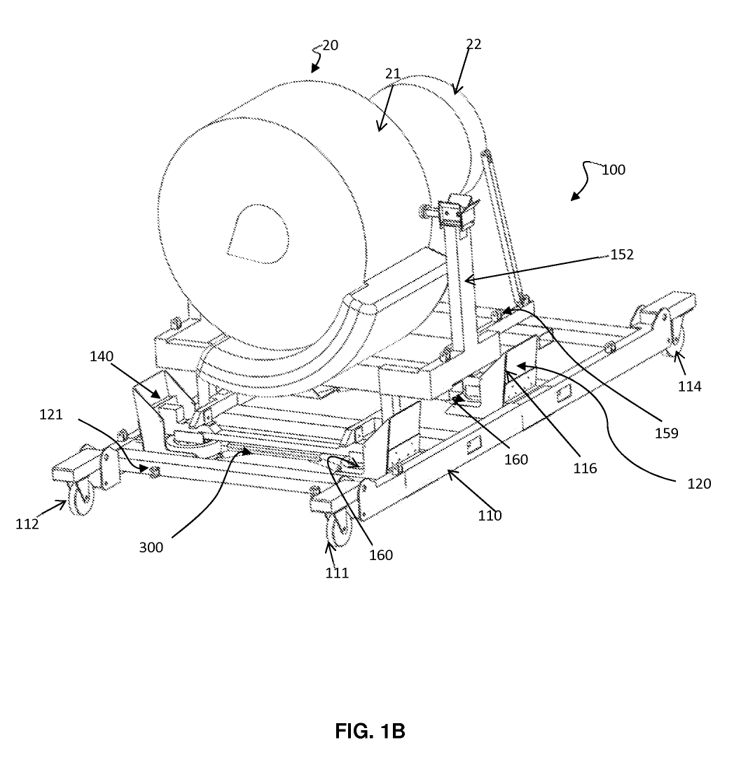

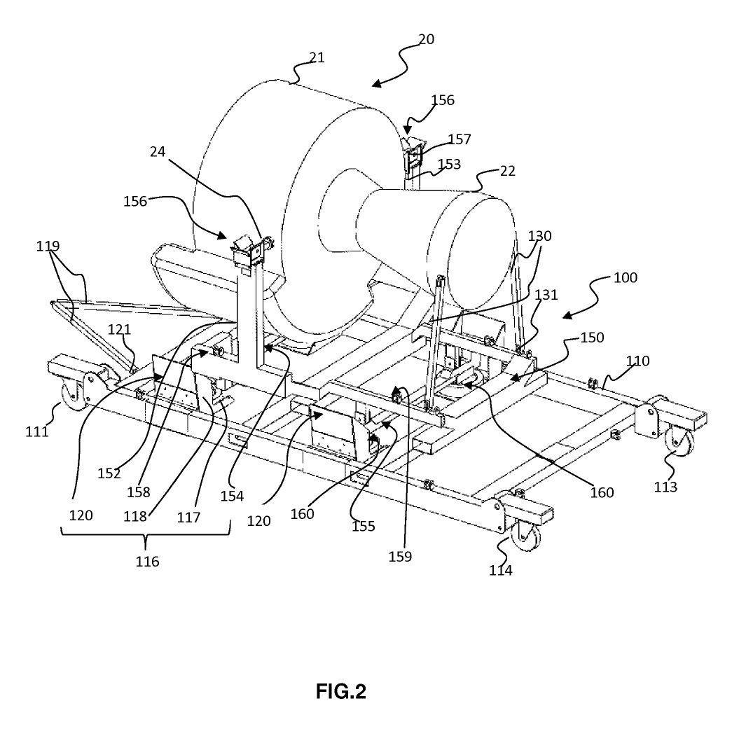

The device 100 according to the invention, as shown schematically in front and rear perspective in FIGS. 1, 3 and 2, comprises a chassis 110 and a cradle 150 for receiving the engine 20. The same reference symbols are used in FIGS. 1 to 3 to designate the same elements.

The chassis 110 is mounted on four idle wheels 111, 112, 113, 114, capable of being blocked in position and braked during different operations of installation/removal or during operations of loading on a vehicle to be transported. These wheels may also be folded and thus retracted to allow the chassis 110 to be solidly secured to the chassis of the transport vehicle.

The cradle 150 comprises more particularly interconnected vertical 152, 153 and transverse 154, 155 posts. The transverse posts 154, 155 of the cradle, also designated “cross-members” in the description hereafter, rest on the chassis 110 and more particularly on pneumatic and/or hydraulic actuators 160, preferably pneumatic, which form an interface between the chassis 110 and the cradle 150.

These actuators, when they are inflated, allow the cradle to be lifted, then lowered as they are deflated, in order to carry out the delicate operations of installation and removal without having the need to use the “bootstrap kit” installation/removal system used up to the present. The cradle 150 is however provided with original attachment points 158, 159 allowing the optional use of the “bootstrap kit.” Another function of these actuators 160 consists of damping the shocks and vibrations during the delicate installation/removal, transport and handling operations, avoiding in particular the costly use of transportation means equipped with air cushion suspensions, but also avoiding the replacement of engine parts, such as ball bearings for example, which could be damaged during inappropriate handling or transportation.

To allow lifting and damping of the cradle, the device comprises at least two actuators 160 placed facing one another on the longitudinal median axis of the chassis. Preferably, the dolly comprises two actuators at the front, on either side of the longitudinal median axis of the chassis 110, to lift the fan 21 of the engine, and an actuator at the rear, along the longitudinal median axis, to support the load of the rear portion 22 of the engine. More preferably, it comprises four actuators 160, between the cradle 150 and the chassis 110, two actuators being disposed at the front facing the fan 21 of the engine and two others at the rear. Such a disposition of the actuators 160 allows maintaining optimum stability of the cradle 150, correctly damping the possible vibrations and shocks, and correctly lifting the cradle.

Preferably, the actuators 160 are of the pneumatic type, and are in the form of actuators with flexible membranes with one, two or three waves. This type of actuator may be inflated by means of compressed air or an inert and stable gas such as gaseous nitrogen for example. In the field of aeronautics, the use of gaseous nitrogen is preferred for inflating this type of actuator. When these actuators are hydraulic, they preferably are in the form of actuators with rigid walls or with flexible membranes and are filled with an incompressible liquid of the oil type. In addition, the actuators may be of hydropneumatic type, that is to say that they combine hydraulic and pneumatic technologies in the same actuator.

All the actuators may be identical, or in identical pairs. In the latter case, the two actuators disposed at the front and designed to support the load of the fan 21 are mutually identical, but differ from the other actuators placed at the rear and designed to support the load of the rear portion 22 of the engine.

In a particular example, the dolly comprises four identical pneumatic actuators, with flexible membranes with two waves. In this case, each of the actuators allows, when it is inflated to a maximum pressure of 8 bars for example, lifting the cradle 150 to a maximum elevation height of 30 cm and supporting a maximum load of 42 kN per actuator at this maximum height.

When the cradle 150 is positioned in the loaded rest position, these actuators 160 are preferably inflated to a pressure comprised between 2 and 9 bars, and more preferably, the inflation pressure is comprised between 4 bars and 8 bars depending on the type of engine, in order to be able to support the weight of the engine and to damp shocks and vibrations. For this purpose, the user may refer to nomograms showing him the inflation pressure of each actuator depending on the type of engine to be supported. Such a pressure allows damping from 7 Hz to 10 Hz to be provided to the cradle-engine assembly with respect to the chassis.

Advantageously, the dolly, as shown in FIG. 1B, comprises a securing and additional damping system of the cradle on each cross-member. The system for securing and additional damping 300 of the cradle comprises at least two damping cylinders 310 and a securing guide 320, the securing guide 320 being fixed to the cradle, each of the damping cylinders 310 being fixed by one of its ends 311 to the chassis and being, by its other end 312, mobile relative to the securing guide 320. In addition, each of the damping cylinders 310 comprises at least one pawl 313 adapted to cooperate with the securing guide 320, preferably so as to allow in the cradle 150 to raise relative to the frame 110 but to prevent the cradle 150 from descending without a retracting action of the pawls 313 associated with each of the damping cylinders 310. Thus, the length of the axis of elongation of the damping cylinders 310 remains substantially constant. Thus, each damping cylinder 310 will always be in its range of maximum damping efficiency.

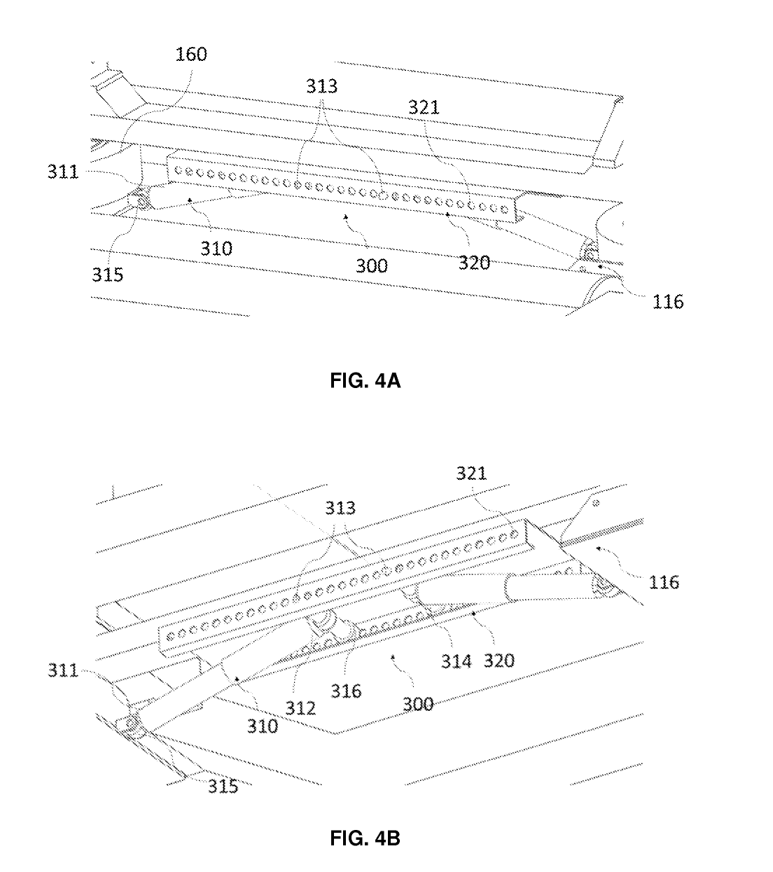

The mobile contact can be provided by any type of slide known to those skilled in the art. Advantageously, the axis may also comprise translational means preferably rotatable along the axis of the damper cylinder, these translation means allow the damping cylinder 310 to maintain a mobile contact with the securing guide 320. The translation means can for example be rollers 316 as shown in FIG. 4B.

Thus, the additional securing and damping system 300 is adapted to create new support points of the cradle on the chassis 110, through the cooperation between the pawls 313 and the securing guide 320, as and when as the cradle 150 is raised. This system therefore has an additional safety function providing motor protection against vibrations and/or shocks, preferably shocks. Indeed, when an actuator 160 is used to raise the cradle 150, the damping cylinders 310 of the securing system and complementary damping cooperate with the securing guide 320 to create new support points of the cradle on the frame. In addition, the presence of shock-absorbing cylinders 310 makes it possible to provide additional damping of shocks and/or vibrations, and more particularly of shocks that may occur during engine installation/removal and transfer operations.

The damping cylinders 310 of the additional securing and damping system may be hydraulic or gas-based and are preferably hydraulic. Advantageously, as shown in FIG. 1B, each of the damping cylinders 310 is fixed by one of its ends 311 to the chassis by means of the support pieces 116. Each of the damping cylinders 310 may be associated with a fastening means 315 enabling the at least a rotational movement, preferably only in rotation, of the damping cylinders 310 around the transversal axis of the end fixed to the chassis. This can be a tenon, a spherical bearing rod, or a clevis.

Preferably, each of the damping cylinders 310 comprises an axis 314 positioned perpendicularly relative to an axis of elongation of the damping cylinders 310. Said axis comprises at its ends at least one pawl 313 and, preferably, it comprises a pawl for each of its ends.

As mentioned, each of the damping cylinders 310 is, by one of its ends in movable contact with the securing guide 320. That is to say, it can move along the securing guide. To that end, the securing guide 320 may comprise a slide or comprise a location in which is housed an end of each of the damping cylinders. As shown in FIGS. 4A and 4B, the securing guide 320 may advantageously have the shape of a guiding rail comprising a plurality of blocking members 321. The blocking members may be, as in FIGS. 4A and 4B, holes, but also teeth, notches or grooves or any arrangement that can cooperate with the pawls so as to maintain in position the damping cylinders 310 relative to the securing guide 320.

The pawls 313 are preferably mobile at least in translation, said translation being for example a horizontal translation perpendicular to the axis of elongation of the damping cylinder. This mobility allows the pawl 313 to be retracted manually or automatically via a control member.

The pawls 313 and the plurality of blocking members 321 are built to allow the pawl to cooperate with the plurality of blocking members 321 so as to allow the cradle 150 to raise relative to the chassis 110 while preventing the cradle 150 to descend without a pawls 313 retracting action associated with each of the damping cylinders. For this, the pawls 313 may for example comprise a wall engageable with the locking members of the securing guide. The pawls 313 may also comprise, as shown in FIG. 4B, an inclined wall allowing the pawl to retract when the cradle raised. Preferably, the inclined wall is inclined relative to a vertical wall of the pawl axis from 30° to 60° and preferably from 40° to 50°. Thus, the end of each damping cylinder 310 is able to move freely in one direction but will be blocked in the other direction.

Advantageously, the pawls 313 are disposed on a transversal axis 314 and are positioned inside the securing guide 320 so that the axis 314 can slide from inside the device to the outside as the cradle is mounted. During the movement, at least some of the pawls 313 is housed in the locking member 321.

In addition, the system may comprise a disengaging means for automatically disengaging the pawls 313 from the blocking members 321 of the securing guide to allow the descent of the cradle when it is desired. This disengagement means advantageously makes it possible to retract the pawls. It can be controlled by an operator.

Thus, in operation, the cradle 150 is advantageously moved in height by the actuators 160, the damping cylinders 310 do not fulfil the purpose of moving the cradle 150. Each of the ends of the damping cylinders 310 is in movable contact with the securing guide 320 and comprises at least one pawl adapted to cooperate with the securing guide. Once the raising phase of the cradle is over, the pawls 313 cooperate with the securing guide 320 so as to ensure an additional point of support of the cradle 150 on the chassis. This is made possible, as shown in FIG. 4B, when the pawls are housed in the locking members of the securing guide. When the cradle 150 is put back by the actuators in low position, the pawls 313 are retracted so as to allow the cradle 150 to descend.

The dolly according to the invention may comprise a plurality of damping cylinders 310. Preferably, it comprises four damping cylinders 310.

Optionally, the dolly further comprises “silentbloc” as shock absorbers 140 positioned in proximity to the actuators 160. These shock absorbers 140 allow an emergency function to be provided, for the case where there would be a leak of the filler fluid of the actuators 160. In such a case, even if the actuators 160 deflate due to a fluid leak, the cradle-engine assembly will be supported on the damping cylinders 310 at first, then in an extreme case on the silentblocs 140, as in the existing dollies chassis configuration.

To this end, the chassis comprises, under the end of each cross-member 154, 155 of the cradles, a support part 116 providing the functions of support for the actuators 160, of abutment for the shock absorbers 140 and of guidance for the cross-members 154, 155. More particularly, each part 116 includes two vertical walls 118 for lateral guidance for the cross-members 154, 155 during lifting of the cradle 150, a horizontal wall 117 parallel to the ground, support for the actuators, and a wall 120 forming an abutment for the shock absorbers 140.

Thus, the support parts 116 include two vertical walls 118 for lateral guidance for the cross-members during lifting of the cradle, a horizontal wall 117 supporting the actuators and a wall forming an abutment 120 for the shock absorbers.

Advantageously, said support parts 116 are in the form of a seat, the seat portion whereof corresponds to the horizontal wall 117 and the back whereof corresponds to the wall forming an abutment 120. In the exemplary embodiment, the support parts 116 are disposed to have a seat portion turned toward the cradle 150, the back corresponds to the wall forming an abutment 120 and may be inclined with respect to a vertical axis from 0° to 89° and preferably from 1° to 20°.

In another configuration, not shown, the support parts 116 in the form of a seat may be disposed in an inverted manner, the horizontal wall forming the seat portion 117 being turned toward the outside of the chassis, the back 120 corresponding to the wall forming an abutment which may be inclined with respect to a vertical axis from 0° to +89° and preferably from +1° to +20°.

Each part 116 thus forms a housing for an actuator 160 and, along its abutment wall 120, a second housing for a shock absorber 140. As described previously, the wall 120 forming an abutment is, preferably, slightly inclined with respect to the perpendicular to the horizontal wall 117, the ends of the cross-members being of a shape suitable for abutment during the movements of the cradle.

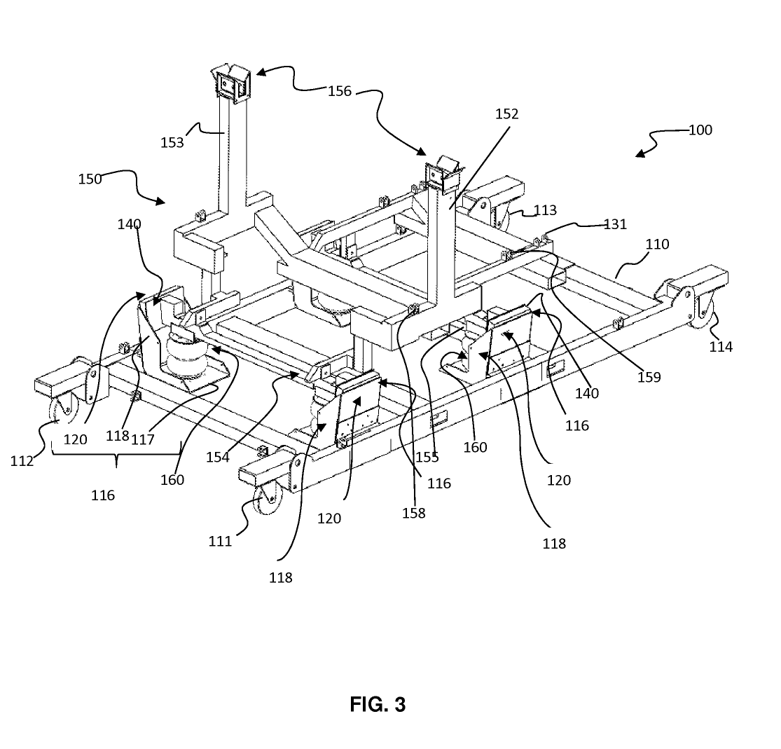

The cradle 150 comprises at least two cross-members 154, 155 disposed against the actuators 160. Preferably, the silentblocs 140 are advantageously attached to the ends of each cross-member 154, 155, and when the cradle 150 is driven in translation toward its lifting position due to the inflation of the actuators 160, the silentblocs 140 are driven with the cross-members 154, 155 and separate slightly from the wall 120 of each support part 116. The lateral vertical walls 118 of each part 116 serve as lateral guides for the cross-members during the rising and descent phase of the cradle 150. FIG. 3 illustrates the installation/removal device according to the invention, the actuators 160 whereof are inflated and the cradle 150 whereof is in the lifting position.

The cradle 150 comprises, on the upper ends of the vertical posts 152, 153, a receiving part 156 designed to accommodate attachment parts 24 attached to the engine 20. The receiving part 156 has an opening, in its upper face, with walls inclined in the shape of a “V,” in order to facilitate the introduction of the attachment parts 24 attached to the engine 20. The attachment parts 24 are advantageously attached to a transverse axis of the engine, prior to the installation or removal of the engine. This system allows the chassis-cradle assembly to be accurately positioned with respect to the engine.

When the actuators 160 are completely deflated, i.e. when the cradle is in an empty rest position, the receiving parts 156 at the ends of the vertical posts 152, 153 of the cradle 150 are located at a distance on the order of 10 cm below the attachment parts 24 of the engine 20.

The example described hereafter allows the procedure implemented for the removal of an engine for the purpose of its maintenance to be understood.

### Removal Phase.

The aircraft is positioned on a flat ground and chocks are positioned under the wheels to avoid any movement of the aircraft during the operation of removal of the engine 20. The usual procedures prior to the removal of the engine 20, such as opening the covers, disconnecting power and fluids, etc. . . . are carried out. The two attachment parts 24, allowing the dolly 100 to take up the weight of the engine 20, are installed and attached directly to the engine 20, on a transverse axis. The dolly, composed of a chassis 110 and a cradle 150, is then moved under the engine 20 using two traction bars 119 attached to one side of the chassis via dedicated attachment points 121, and to the other to a handling tractor, not shown in the schematic. The cradle 150 is then in the low empty rest position, i.e. the actuators 160 are empty and the “silentblocs” 140 are in contact both with the cross-members 154, 155 of the cradle 150 and the wall 120 of each part 116 of the chassis. The dolly is positioned under the wing of the aircraft, facing the engine 20, so that the attachment parts 24 previously attached to the engine 20 are located as perpendicular to the “V’ shaped receiving parts 156 on the upper end of the vertical posts 152, 153 of the cradle 150 as possible.

The front and rear actuators 160 then begin to be pressurized in order to inflate them and to lift the cradle 150 with respect to the chassis and thus, to allow the attachment parts 24 to accurately get into the position of the receiving parts 156 provided for this purpose on the upper end of the vertical posts 152, 153 of the cradle, thanks to the “V”-shaped openings. The entire dolly 100 therefore positions itself with respect to the engine 20 during this first positioning step. Such a dolly, the cradle 150 whereof is in the raised position due to the inflation of the actuators 160, is shown schematically in FIG. 3.

During the descent phase, the securing guide 320, secured to the cradle undergoes a vertical translation. During this vertical translation, the damping cylinders 310, preferably conserving a substantially constant length, is rotated along the transverse axis of its fastening means 315. For example, the translation means bear against the securing guide and the axis 314 of each of the damping cylinders 310 moves horizontally towards the outside of the device. Advantageously, pawls engage successively on the locking members.

As soon as the attachment parts 24 are positioned in the receiving parts 156, the lifting of the cradle 150 is momentarily interrupted. The four idle wheels 111, 112, 113, 114 are blocked and braked. The operator(s) may then install and attach one or two support bars 130 of the rear portion 22 of the engine. This (these) bar(s) is (are) advantageously attached at one end 131 to the lower portion of the cradle, the other end attaching to the rear portion 22 of the engine 20. The operator(s) further attach transverse pins 157 allowing the attachment parts 24 to be retained in their housings 156. The actuators 160 are again filled to obtain a pressure corresponding to the lifting height necessary for supporting the engine. This pressure is advantageously comprised between 1 bar and 10 bars, preferably between 1 bar and 8 bars depending on the type of engine. It may be determined based on a corresponding installation nomogram for the type of engine to be installed. The pressure indicated for each actuator 160, or each pair of actuators, then corresponds to the pressure required for load-shedding the wing of the aircraft of the weight of the engine 20 in order to allow the operators to unscrew the engine attachment bolts when these are not constrained. The weight of the engine 20 is then entirely supported by the actuators 160.

As soon as the engine attachment bolts are removed, the actuators 160 begin to be emptied in order to reduce pressure and cause the cradle-engine assembly to drop gently until all the rubbers 140 are in their housings in contact with the abutment wall 120 of the chassis 110. The dolly 100, loaded with its engine 20, is then moved by a few meters using traction bars 119 and the handling tractor to leave the underwing area. The actuators are not necessarily completely emptied; a small amount of pressure may remain so that the actuators may play their role as dampers, but the cradle must be sufficiently low to allow the engine to be disengaged from the underwing area while avoiding shocks. This step is called the “disengagement step.”

During the descent phase, the securing guide 320, secured to the cradle is vertically translated towards the ground. During this vertical translation, the damping cylinders 310, preferably conserving a substantially constant length, is rotated along the transversal axis of its fastening means 315. For this, the pawls are voluntarily disengaged by an operator via a command. For example, the translation means bear against the securing guide and the axis 314 of each of the damping cylinders 310 moves horizontally towards the inside of the device.

If the command control of the operator is interrupted, the pawls are reengaged and lodged themselves in the locking member so as to interrupt the descent of the cradle-engine assembly. Advantageously, the securing and damping system is also configured to reengage the pawls in case of failure of at least one actuator.

### Transportation Phase:

Once the engine 20 is safely outside the underwing area, a damping step consists of again filling the actuators 160 simultaneously until a pressure corresponding to the height of the loaded rest position, designed to effectively damp shocks and vibrations. For this purpose, this pressure could be determined based on damping nomograms corresponding to the type of engine to be transported. Typically, it is advantageously comprised between 2 and 9 bars, and more advantageously between 4 bars and 8 bars, depending on the type of engine to be transported. Such a pressure allows in particular providing damping comprised between 7 Hz and 10 Hz of the cradle-engine assembly with respect to the chassis. The dolly, in this configuration, may then be moved to the loading area, then loaded, once the idle wheels are braked and/or folded, onto a transportation means, to be transported in complete safety.

It should be noted that during these steps of installation-removal, the actuators allow to raise or lower the entire cradle-engine while the securing system and additional damping makes it possible to secure the entire cradle-engine. Indeed, in the event of failure of the actuators, the system of securing and damping via the shock-absorbing cylinders 310 will support the cradle-engine combination cumulating position maintaining and damping of the shock associated with such failure.

### Installation Phase:

The installation phase is similar to the removal phase, but with the steps reversed. Thus, at first, the dolly 100 loaded with its engine 20 is moved into the underwing area. In this first step, the actuators 160 are not necessarily completely emptied; there may remain a little pressure so that the actuators may play their role as dampers, but the cradle must be sufficiently low to allow the positioning of the engine in the underwing area while avoiding shocks. The dolly 100 is positioned under the wing of the aircraft, perpendicular to an attachment marker of the engine 20. The four idle wheels 111, 112, 113, 114 are blocked and braked. The actuators 160 are then filled again to obtain a pressure corresponding to the lifting height necessary for attaching the engine to the wing. This pressure is advantageously comprised between 1 bar and 10 bars, and preferably between 1 bar and 8 bars depending on the type of engine. This pressure allows the weight of the engine to be supported and to lift it to the necessary height to allow the operators to attach it to the wing and to screw the engine attachment bolts without constraining them. The weight of the engine 20 is then completely supported by the actuators 160. Once the engine is attached to the wing, the actuators 160 are slightly deflated to cause the weight of the engine to be progressively supported by the wing. This deflation is interrupted to allow the operator to detach the support bar(s) 130 from the rear portion 22 of the engine as well as the transverse pins 157 allowing the attachment parts 24 to be retained in their housings 156, in order to free the attachment parts 24 of the engine 20 from the receiving parts 156 of the cradle 150. The dolly is then completely detached from the engine and no longer supports the weight of the engine. The actuators 160 may be completely deflated in order to lower the cradle into an empty rest position.

During the transport phase, the pawls of the securing and additional damping system are engaged in the blocking members. Thus, when the cradle-engine assembly is in rest position and loaded, that is to say in a second rest position loaded, the actuator allows damping vibrations and/or shocks functions suffered by the cradle-engine assembly relative to the chassis while the securing and additional damping system allows secondary or complementary damping functions. The combination of the actuators and the damper therefore makes it possible to achieve a higher level of safety during the operations of installing/removing and transferring the aircraft engine. In addition, it has been observed that the presence of the additional security and damping system can reduce the resonance frequency oscillations that may occur during transport on some routes.

Such a dolly, thus configured, may be installed on a standard vehicle, such as a truck or a trailer, without being obligated to use a transporter equipped with equipment designed especially to damp the frequencies comprised between 7 Hz and 10 Hz prescribed by the main engine builders. Moreover, thanks to the configuration of this dolly, the engine is damped as of its removal phase, unlike existing dollies which run a non-negligible risk of shocks during the phases of engine descent, of transportation between the removal area and the loading area, and of loading into a transportation means equipped with suitable suspensions.

The dolly which has just been described allows not only a reduction in the risk connected with shocks that may occur on fragile parts of the engine when it is not in operation, but also a reduction in the installation/removal time. In fact, it allows accomplishing by itself all the steps of installation and removal, without necessitating the use of a “bootstrap kit” installation/removal system used until the present to install and remove the engine and to place it on the cradle of the dolly. Moreover, the risk connected to the installation of a “bootstrap kit” above the engine is eliminated during the use of the dolly described.

1. An aircraft engine installation/removal and transfer device in the form of a dolly comprising, a chassis mounted on idle wheels, a cradle for receiving said engine, wherein pneumatic and/or hydraulic actuators disposed as an interface between the chassis and the cradle and adapted to lift the cradle with respect to the chassis and to damp shocks and/or vibrations, said being further adapted to lift the cradle into a first lifting position necessary for installing/removing the engine, then to hold the engine in a second loaded rest position to damp vibrations and/or shocks undergone by the cradle and the engine with respect to the chassis.

2. The device according to claim 1, wherein the dolly comprises at least one additional securing and damping system, said additional securing and damping system comprising at least two damping cylinders and a securing guide, said securing guide being fixed to the cradle, each of the damping cylinders being fixed at one end to the frame and being, at another end, mobile relative to the security guide.

3. Device according to claim 2, wherein each of the damping cylinders of the additional securing and damping system comprises at least one pawl adapted to cooperate with the securing guide.

4. Device according to claim 2, wherein the chassis comprises support parts forming a housing for the actuators, each of the damping cylinders being fixed at one of its ends to the chassis through said support parts.

5. Device according to claim 2, wherein each of the damping cylinders comprises opposite pawls extending from opposite ends of a pawl axis that is perpendicular to an axis of elongation of the damping cylinder.

6. Device according to claim 3, wherein the securing guide has a shape of a guide rail having a plurality of blocking members adapted to cooperate with the at least one pawl so as to maintain the damping cylinders in position relative to the securing guide.

7. Device according to claim 1, wherein the cradle comprises at least two cross-members resting on said actuators, at the ends of which are attached shock absorbers, and wherein the chassis comprises support parts forming a housing for the actuators.

8. The device according to claim 7, wherein the support parts include two vertical walls for lateral guidance for the cross-members during lifting of the cradle, a horizontal wall, support for the actuators, and a wall forming an abutment for the shock absorbers.

9. The device according to claim 8, wherein the support parts each are in the form of a seat having a seat portion corresponding to the horizontal wall and a back corresponding to the wall forming the abutment.

10. The device according to claim 9, wherein said support parts are disposed to have the seat portion turned toward the cradle, and the back being inclined with respect to a vertical axis from 0° to −89°.

11. The device according to claim 1, wherein when the actuators are pneumatic they are inflated with air or with an inert and stable gas, and when they are hydraulic they are filled with an incompressible liquid.

12. The device according to claim 1, wherein when the actuators are pneumatic, a necessary pressure for attaining the first lifting position and relieve a wing of an aircraft of the weight of the engine is between 1 bar and 10 bars; and a necessary pressure for holding the cradle loaded with the engine in the second loaded rest position is between 2 bars and 9 bars.

13. The device according to claim 1, wherein when the actuators are pneumatic, they are actuators with flexible membranes with at least one wave, and when they are hydraulic, they are actuators with rigid walls or with flexible membranes.

14. The device according to claim 1, comprising at least two said actuators disposed along a longitudinal median plane of the chassis.

15. The device according to claim 1, comprising at least three said actuators, at least two of which are disposed at a front of the chassis on either side of a longitudinal median axis of the chassis.

16. The device according to claim 1, wherein the actuators are four in number, each being disposed as an interface between an end of a cross-member of the cradle and the chassis, and wherein at least the actuators disposed under the same cross-member of the cradle are in identical pairs.

17. The device according to claim 1, wherein the cradle comprises on upper ends of two vertical posts a receiving part an upper surface of which has an opening with walls inclined in the shape of a “V” in order to facilitate introduction of attachment parts attached to the engine.

18. The device according to claim 1, further comprising one or two support bars of a rear portion of the engine.

19. The device according to claim 1, wherein the idle wheels are adapted to be folded.

20. An aircraft engine installation/removal and transfer method using the device according to claim 1, such that during removal of an engine from an aircraft wing the method comprises the following steps:
a first step of positioning the dolly perpendicular to the engine, and of inflating the actuators to position the cradle so that attachment parts, previously attached to the engine, are inserted into receiving parts disposed at an end of vertical posts of the cradle;
a second load-shedding step comprising inflating the actuators to a load-shedding pressure for relieving the wing of the aircraft from the weight of the engine, and separating the engine from the aircraft wing;
a third disengagement step during which the actuators are deflated to lower the cradle to a height allowing movement of the dolly out from under the aircraft wing;
a fourth damping step comprising inflating the actuators to a pressure for damping the cradle and the engine supported thereby, said cradle then being in a loaded rest position;
a fifth step comprising moving the dolly toward a loading area, then loading it on a transportation means;
where during installation of the engine, the steps implemented are performed in the reverse order compared to removal.
